(19) United States
(12) Patent Application Publication
(10) Pub. No.: US 2026/0256543 A1
(43) Pub. Date: Sep. 3, 2026

(54) TOOTH EXTRACTION DEVICE

(71) Applicant: HELMUT ZEPF MEDIZINTECHNIK GMBH, Seitingen-Oberflacht (DE)

(72) Inventor: Patrick ZEPF, Seitingen-Oberflacht (DE)

(21) Appl. No.: 19/164,760

(22) PCT Filed: Mar. 6, 2024
(86) PCT No.: PCT/EP2024/055762

§ 371 Date: Sep. 12, 2025

(30) Foreign Application Priority Data
Mar. 13, 2023 (DE) 10 2023 106 175.5

(51) Int. Cl. A61C 3/14

(52) U.S. Cl. CPC A61C 3/14

(57) ABSTRACT

A device for tooth extraction includes a base element with a longitudinal axis, a distal end and a proximal end, and a pulling carriage which can be moved relative to the base element and has a distal end and a proximal end. The device includes a pulling element having a first end and a second end. A first fastening device for fastening to the tooth or a fastening body fastened to the tooth is arranged at the first end, and a second fastening device for fastening to the pulling carriage is arranged at the second end. The pulling element is guided via a deflection part arranged on the base element. A tensioning device for generating a tensile force is arranged on the pulling carriage. The tensioning device can be actuated by means of an actuating element which is rotatable about the longitudinal axis and has a torque limiting device.

The invention relates to a device for tooth extraction according to the preamble of patent claim 1.

EP 1 578 296 B1 discloses a device for tooth extraction with a base element having a longitudinal axis, a distal end and a proximal end and a pulling carriage which is displaceable relative to the base element and has a distal end and a proximal end, and with a pulling element having a first end and a second end, wherein a first fastening device for fastening to the tooth or a fastening body fastened to the tooth is arranged at the first end and a second fastening device for fastening to the pulling carriage is arranged at the second end, wherein the pulling element is guided over a deflection part arranged on the base element, wherein a tensioning device for generating a tensile force is arranged on the pulling carriage, wherein the tensioning device can be actuated by means of an actuating element.

Such a device enables the extraction of a tooth, whereby in the following the term tooth always refers to a complete tooth as well as a part of a tooth, for example the tooth root, or dental prostheses such as dental crowns or dental implants. The device can be partially inserted into the mouth and supported there, whereby the force can be applied outside the oral cavity by means of the tensioning device and directed via the pulling element into the oral cavity and via the deflection part to the tooth to be extracted. The actuating element is designed as a knurled nut. If the knurled nut is tightened too much, there is a risk that the pulling element will tear or break.

The object of the invention is therefore to further develop a device for tooth extraction in such a way that the risk of damage to the pulling element is reduced.

The object is achieved according to the invention by a device for tooth extraction comprising the features of patent claim 1.

Advantageous embodiments and further developments of the invention are specified in the dependent claims.

The device according to the invention for tooth extraction with a base element with a longitudinal axis, a distal end and a proximal end and a pulling carriage which can be moved relative to the base element and has a distal end and a proximal end, and with a pulling element with a first end and a second end, wherein a first fastening device for fastening to the tooth or a fastening body fastened to the tooth is arranged at the first end and a second fastening device for fastening to the pulling carriage is arranged at the second end, wherein the pulling element is guided via a deflection part arranged on the base element, wherein a tensioning device for generating a tensile force is arranged on the pulling carriage, wherein the tensioning device can be actuated by means of an actuating element which can be rotated about the longitudinal axis, is characterized in that the actuating element comprises a torque limiting device. A torque limiting device ensures that when a certain torque is applied, no higher force can be transferred from the actuating element to the tensioning device. The tensioning device and in particular the pulling element can thus be protected from damage.

Preferably, the actuating element can be operated manually. The torque limiting device is preferably a mechanical torque limiting device. The device can therefore be designed as a purely mechanical device which does not require any electrical or electronic components.

The torque limiting device can be set at the factory to a defined torque, which has been shown, for example, in clinical studies to be a useful maximum value for tooth extraction.

According to an advantageous embodiment of the invention, the torque limiting device comprises a first and a second frictionally connectable clutch disc. Such a design enables a compact construction of the torque limiting device.

Preferably, the actuating element has a torque shaft which can be connected to the tensioning device and on which the first clutch disc is arranged in a rotationally fixed manner, wherein the actuating element further has a first housing part on which the second clutch disc is arranged in a rotationally fixed manner, wherein the first housing part is arranged so as to be rotatable relative to the torque shaft. Such an arrangement enables a compact structure, in particular a structure with a short axial length.

Advantageously, the torque shaft has at least one longitudinal groove, at least in sections, wherein the first clutch disc has a projection on its inner edge which engages in the longitudinal groove. Such a design makes it easy to create a reliable, non-rotatable connection. Particularly preferably, the torque shaft has at least three or four longitudinal grooves, at least in sections, and the first clutch disc has a corresponding number of projections on its inner edge in order to enable the most even force distribution possible.

Advantageously, the first housing part has a cylindrical wall, wherein at least one longitudinal groove is arranged in the wall, wherein the second clutch disc has a projection engaging in the longitudinal groove on its outer edge. Such a design makes it easy to create a reliable, non-rotatable connection. Particularly preferably, the first housing part has at least in sections three or four longitudinal grooves in its wall and the second clutch disc has a corresponding number of projections on its outer edge in order to enable the most even force distribution possible.

An advantageous development of the invention provides that the first housing part has a bottom surface, wherein an opening is arranged in the bottom surface through which the torque shaft is guided with a first section into the first housing part, wherein a contact surface for the first housing part is arranged on the torque shaft. Such an arrangement enables the most compact construction possible.

According to a preferred embodiment of the invention, an external thread is arranged on the torque shaft, in particular on the first section, onto which an adjusting nut can be screwed, wherein the first and the second clutch disc are arranged between the bottom surface of the first housing part and the adjusting nut. The desired force between the two clutch discs can be set using the adjusting nut.

A particularly preferred embodiment of the invention provides that at least one disc spring is arranged between the bottom surface of the first housing part and the adjusting nut, preferably two disc springs are arranged. The disc springs enable improved power transmission. In particular, the disc springs have no projections on either their outer or inner edges and are therefore mounted so that they can rotate both against the torque shaft and against the first housing part.

Preferably, at least one spacer disc is arranged between the bottom surface of the first housing part and the first clutch disc and/or between the second clutch disc and the at least one disc spring and/or between the at least one disc spring and the adjusting nut. Such spacer discs increase the distance between the respective components. In particular, the spacer discs have no projections on either their outer or inner edges and are therefore mounted so that they can rotate both against the torque shaft and against the first housing part.

Particularly preferably, a second housing part can be screwed onto the first housing part. This allows the components of the torque limiting device to be protected and, in particular, to be arranged inaccessible in a closed housing. For example, after factory setting of the desired torque at which the torque limiting device is to be triggered, the second housing part can be screwed to the first housing part and, in particular, permanently connected to it in order to prevent the user from changing the set torque.

Advantageously, a sealing ring is arranged between the first housing part and the torque shaft and/or between the second housing part and the torque shaft in order to prevent dirt or cleaning agents when the actuating element is cleaned from penetrating into the torque limiting device.

The pulling element is advantageously designed as a wire, a rope or a string, whereby a certain flexibility in the positioning of the pulling element relative to the tooth to be extracted can be achieved.

Preferably, the second fastening device comprises a partially spherical element having a diameter which is larger than the diameter of the pulling element, wherein in particular a longitudinal axis of the pulling element is arranged coaxially to an axis of symmetry of the partially spherical element, and wherein the pulling carriage has at least one blind hole which has a lateral slot pointing towards the distal end of the pulling carriage. A second fastening device designed in this way enables a particularly easy-to-handle fixation of the pulling element to the pulling carriage by simply suspending the partially spherical element into the blind hole and guiding the pulling element through the lateral slot in the direction of the distal end. The partially spherical element reliably rests against the wall of the blind hole.

Preferably, the pulling carriage has at least two, preferably four, blind holes arranged next to one another in the longitudinal direction, each of the blind holes having a lateral slot pointing towards the distal end of the pulling carriage. A number of blind holes allow easy adaptation to the anatomical conditions of a patient.

A preferred embodiment of the invention provides that the second fastening device comprises a pin-like element with a diameter which is larger than the diameter of the pulling element and with a longitudinal axis which is arranged parallel to the longitudinal axis of the pulling element, wherein the partially spherical element is arranged on the pin-like element, and the diameter of the partially spherical element is larger than the diameter of the pin-like element. Such a pin-like element can improve the positioning of the second fastening device in the blind hole by the pin-like element coming to lie in the lateral slot.

A particularly simple and reliable connection between the second fastening device and the pulling element can be made possible if the pin-like element is preferably designed as a press bushing into which the pulling element is pressed.

According to an advantageous development of the invention, the pin-like element has a length which is greater than the length of the partially spherical element, wherein in particular the pin-like element projects in the longitudinal direction on both sides beyond the partially spherical element. Such a configuration can further improve the positioning of the second fastening device.

Preferably, the blind hole closest to the proximal end of the pulling carriage has a lateral slot pointing towards the proximal end of the pulling carriage. Such a configuration can further improve the positioning of the second fastening device by having the pin-like element lie in two diametrically opposite slots of a blind hole.

A particularly preferred embodiment of the invention provides that the base element has a measurement standard and a marking for interaction with the measurement standard is arranged on the pulling carriage. A measurement standard can visualize to the user the distance the pulling carriage has already moved.

According to an advantageous development of the invention, the base element is designed to be open to an upper side in a first section and has a groove running in the longitudinal direction, wherein the pulling carriage is arranged to be longitudinally displaceable in the groove. Such a groove allows good guidance of the pulling carriage and can be easily cleaned.

A preferred embodiment of the invention provides that the base element, starting from the proximal end, has a second section in which the base element is tubular with an axial through-opening, wherein the through-opening merges into the groove of the first section, and the pulling carriage is arranged so as to be longitudinally displaceable in the groove and the through-opening. By such a design the guidance of the carriage and its cleanability can be improved.

Preferably, the deflection part is arranged at a distal end of the groove, wherein the groove has an opening below the deflection part. This allows the deflection part to be arranged in a protected manner within the groove. The deflection part can, for example, be designed as a deflection roller, which can be fastened by means of a pin that crosses the groove.

A preferred development of the invention provides that at the distal end of the base element on an underside of the base element, in particular distal to the opening, a first support element is arranged, preferably detachably fastened, which has a positioning contour for aligning the pulling element. Such a positioning contour can ensure the alignment of the pulling element in the direction of the tooth to be extracted and thus facilitate the attachment of the first end of the pulling element to the tooth to be extracted or to a fastening body attached to the tooth.

Preferably, the positioning contour is concave, whereby a lateral deflection of the pulling element can be prevented. Particularly preferably, the positioning contour is V-shaped.

According to an advantageous embodiment of the invention, at least one second support element is arranged on an underside of the base element, in particular proximal to the opening, preferably in a detachable manner. Such a support element can enable flexible placement of the device in the oral cavity.

Advantageously, the tensioning device comprises a threaded rod arranged at the proximal end of the pulling carriage, which is led out of the base element through a support sleeve arranged at the proximal end of the base element, wherein the actuating element is screwed onto the threaded rod with an internal thread and is arranged so as to be axially supported on the support sleeve in order to generate the tensile force, and wherein a spring element for generating a restoring force is arranged between the pulling carriage and the support sleeve. Such a tensioning device enables a structurally simple design.

According to an advantageous embodiment, the support sleeve is screwed onto the proximal end of the base element by means of a threaded connection. Such a design enables the device to be disassembled and subsequently cleaned in a particularly simple manner.

Particularly preferably, the actuating element has an inner contour which can be placed in a form-fitting manner on an outer contour of the support sleeve. The inner contour can, for example, be arranged on the side of the actuating element facing away from the tensioning device. To disassemble the device, after loosening the connection between the actuating element and the tensioning device, the actuating element can be turned over and placed with the inner contour on the outer contour of the support sleeve in order to unscrew the support sleeve from the base element. A separate tool for disassembling the device is therefore not required.

The invention is explained in detail with reference to the following figures. It shows

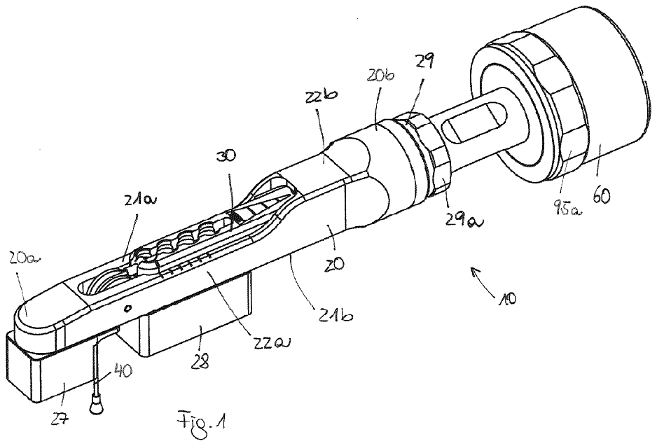

FIG. 1 is a perspective view of an embodiment of a device for tooth extraction according to the invention,

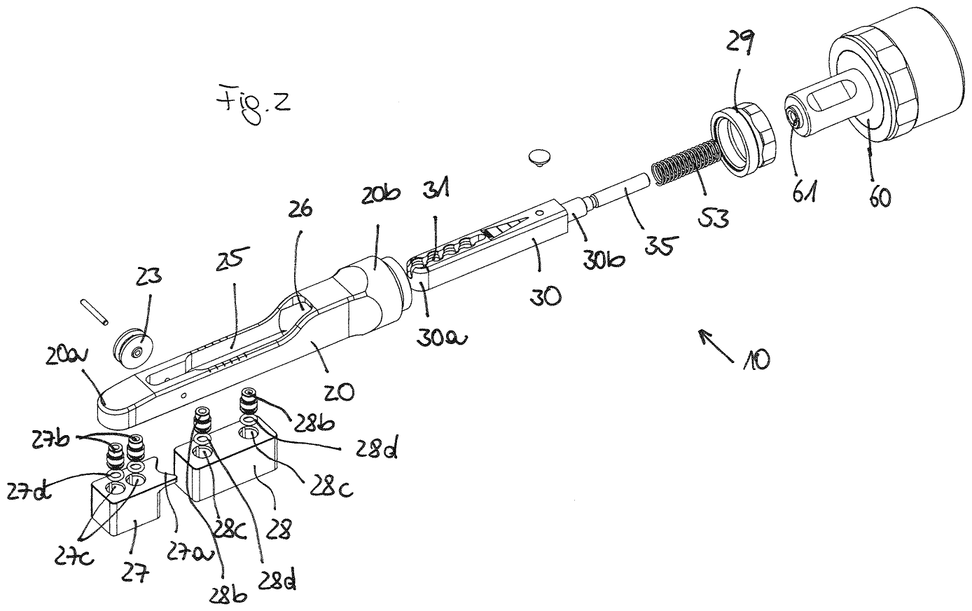

FIG. 2 is an exploded view of the device according to FIG. 1,

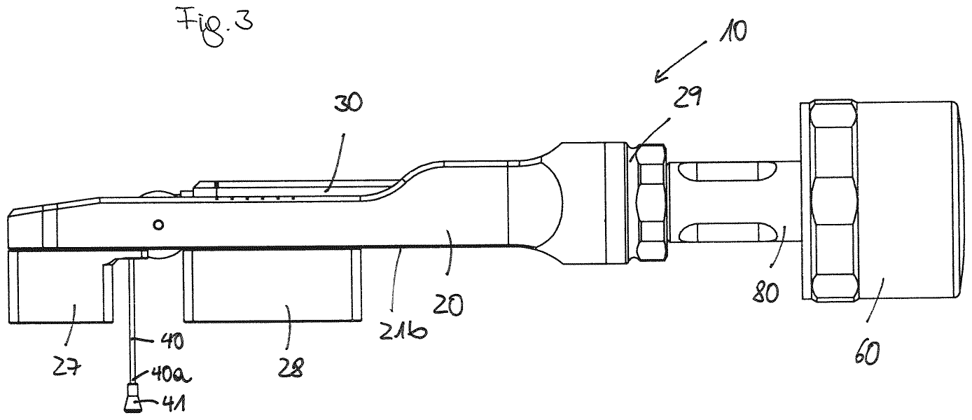

FIG. 3 is a side view of the device according to FIG. 1,

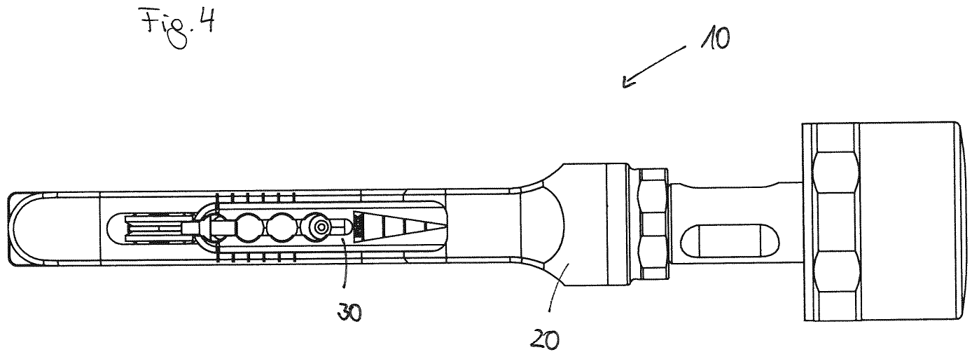

FIG. 4 is a plan view of the device according to FIG. 1,

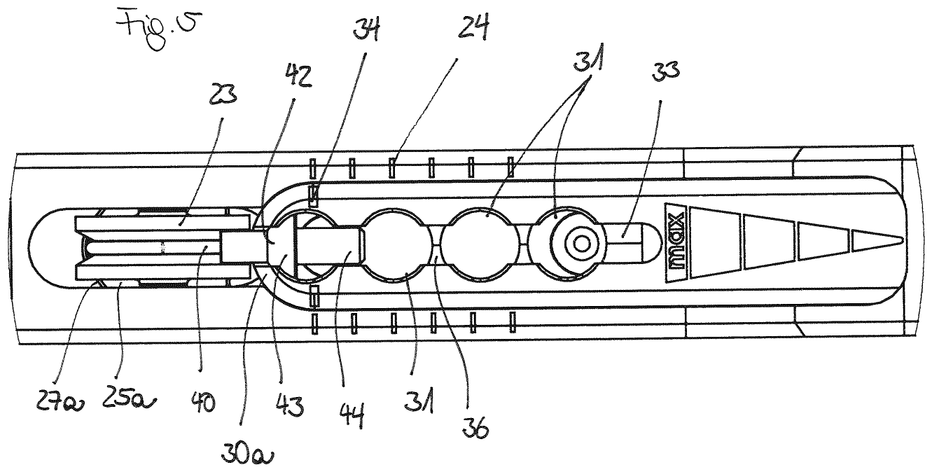

FIG. 5 is an enlarged detail of FIG. 4,

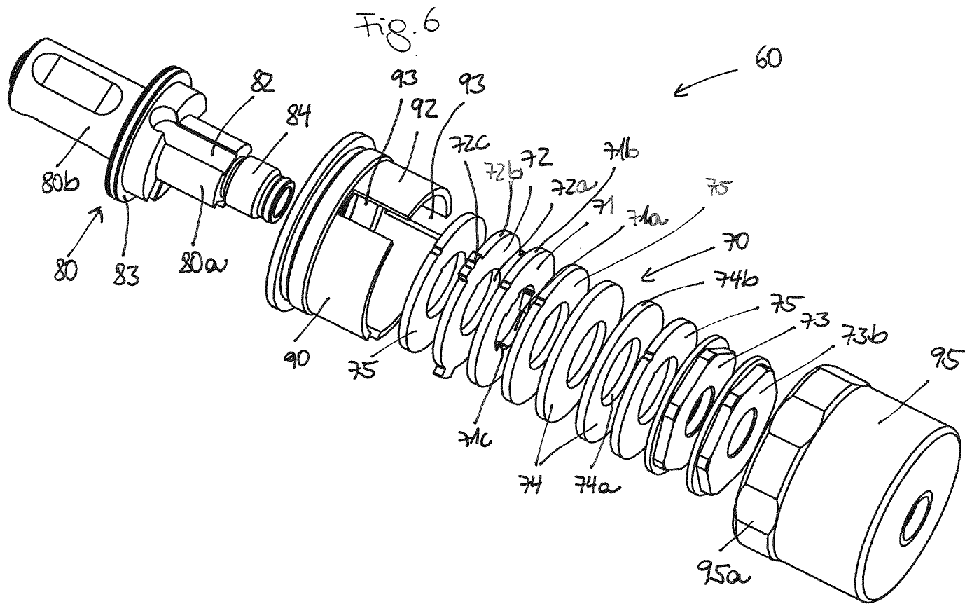

FIG. 6 is an exploded view of the actuating element of the device according to FIG. 1,

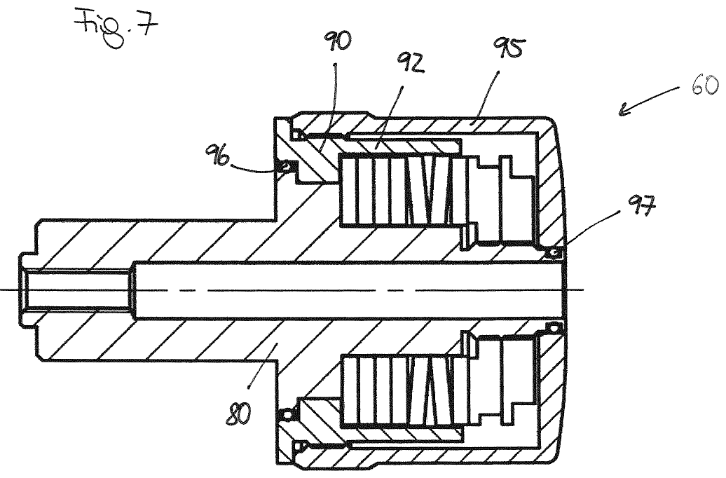

FIG. 7 shows a longitudinal section through the actuating element of the device according to FIG. 1,

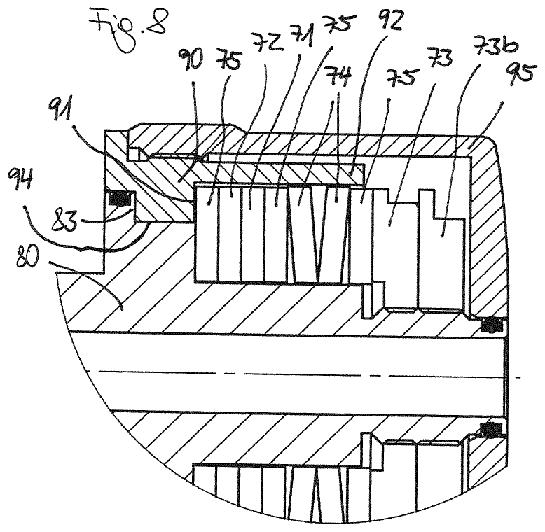

FIG. 8 is an enlarged detail of FIG. 7 and

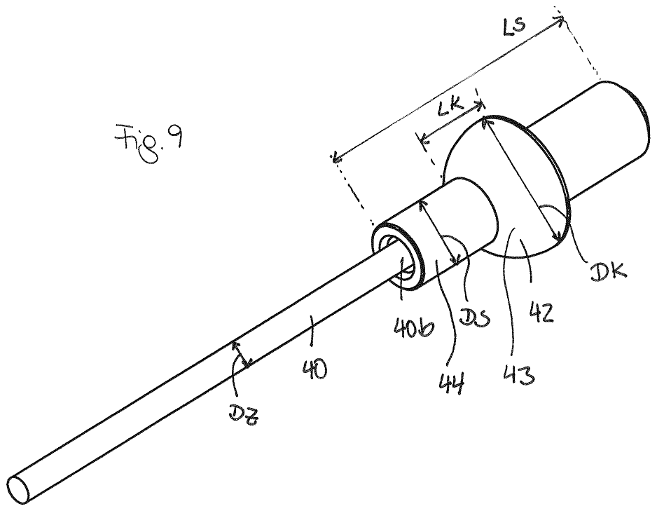

FIG. 9 is a perspective view of the second end of the pulling element of the device according to FIG. 1.

FIGS. 1 to 9 show different views of an embodiment of a device 10 for tooth extraction and components thereof.

The device 10 for tooth extraction comprises a base element 20 with a longitudinal axis L, a distal end 20a and a proximal end 20b and a pulling carriage displaceable relative to the base element 20 and having a distal end 30a and a proximal end 30b. Furthermore, the device 10 comprises a pulling element 40 with a first end 40a and a second end 40b, wherein a first fastening device 41 for fastening to the tooth or a fastening body fastened to the tooth is arranged at the first end 40a and a second fastening device 42 for fastening to the pulling carriage 30 is arranged at the second end 40b. The pulling element 40 is guided over a deflection part 23 arranged on the base element 20. The deflection part 23 causes the pulling element 40 to be deflected by approximately 90°. While a section of the pulling element 40 adjacent to the second fastening device 42 is arranged substantially parallel to the longitudinal axis L of the device 10, a section of the pulling element 40 adjacent to the second fastening device 41 is arranged substantially transversely to the longitudinal axis L of the device 10, in particular in the extraction direction of the tooth to be extracted.

A tensioning device 50 for generating a tensile force is arranged on the pulling carriage 30, wherein the tensioning device 50 can be actuated in particular manually by means of an actuating element 60 which is rotatable about the longitudinal axis L. The tensioning device 50 can comprise a threaded rod 35 arranged at the proximal end 30b of the pulling carriage 30, which is led out of the base element 20 through a support sleeve 29 arranged at the proximal end 20b of the base element 20. The support sleeve 29 is in particular screwed onto the proximal end 20b of the base element 20 by means of a threaded connection. The actuating element 60 can be screwed onto the threaded rod 35 with an internal thread 61 and can be arranged to be axially supported on the support sleeve 29 in order to generate the tensile force. The tensioning device 50 may further comprise a spring element 53 which is arranged between the pulling carriage 30 and the support sleeve 29 to generate a restoring force. If the actuating element 60 is rotated about the longitudinal axis L, the threaded rod 35 is screwed into or unscrewed from the actuating element 60 depending on the direction of rotation. The spring element 53 causes the actuating element 60 to rest against the support sleeve 29. If the threaded rod 35 is screwed into the actuating element 60, the pulling carriage 30 is moved relative to the base element 20 to the proximal end 20b of the base element 20 and a tensile force is exerted on the pulling element 40.

As can be seen in particular in FIG. 4 and FIG. 5, the base element 20 can have a measurement standard 24, for example in the form of a scale with several equidistantly arranged markings. A marking 34 for interaction with the measurement standard 24 can be arranged on the pulling carriage 30. If the pulling carriage 30 is moved relative to the base element 20, the marking 34 moves relative to the measurement standard 24 so that the distance travelled can be recorded.

The base element 20 can have a first axial section 22a and a second axial section 22b, which in particular borders the proximal end 20b of the base element 20. In the first section 22a, the base element 20 is open to an upper side 21a and has a groove 25 running in the longitudinal direction, wherein the pulling carriage 30 is arranged to be longitudinally displaceable in the groove 25. In particular, the pulling carriage 30 is accessible in the first section 22a from the upper side 21a, but is otherwise arranged embedded in the base element 20. In the second section 22b, the base element 20 is tubular with an axial through-opening 26, wherein the through-opening 26 merges into the groove 25 of the first section 22a, and the pulling carriage 30 is arranged to be longitudinally displaceable in the groove 25 and the through-opening 26. The base element 20 can be made in one piece from a solid material rod.

The deflection part 23 is arranged in particular at a distal end of the groove 25. For example, the deflection part 23 can be designed as a deflection roller, which can be arranged by means of a cross pin on the side walls of the groove 25 and can be mounted so as to be rotatable about the cross pin. The groove 25 can have an opening 25a below the deflection part 23, through which the pulling element 40 can be guided towards the tooth to be extracted.

The pulling element 40 can be designed as a wire, a rope or a string and has a diameter DZ.

The first fastening device 41 of the pulling element 40 can, for example, be designed as a hook or thickening which can engage in a corresponding eyelet or recess of a fastening body screwed into the tooth to be extracted.

The second fastening device 42 comprises in particular a partially spherical element 43 with a diameter DK which is larger than the diameter DK of the pulling element 40 (cf. in particular FIG. 9). For example, the partially spherical element 43 can be designed as a hemisphere. In particular, a longitudinal axis of the pulling element 40 is arranged coaxially to an axis of symmetry of the partially spherical element 43. The curvature of the partially spherical element 43 points in particular in the direction of the first end 40a of the pulling element 40. The second fastening device 42 can comprise in addition to the partially spherical shaped element 43 a pin-like element 44 with a diameter DS which is larger than the diameter DZ of the pulling element, but smaller than the diameter DK of the partially spherical element 43. The longitudinal axis of the pin-like element 44 is arranged parallel to the longitudinal axis of the pulling element 40. The pin-like element 44 can be designed as a press bushing into which the pulling element 40, in particular the second end 40b of the pulling element 40, is pressed. The partially spherical element 43 can be arranged on the pin-like element 44. The pin-like element 44 can have a length LS which is greater than the length LK of the partially spherical element 43, wherein in particular the pin-like element 44 projects in the longitudinal direction on both sides beyond the partially spherical element 43. In other words, the spherical element 43 is penetrated by the pin-like element 44.

The pulling carriage 30 can have at least one blind hole 31 which has a lateral slot 32 pointing towards the distal end 30a of the pulling carriage 30 (see in particular FIGS. 4 and 5). Preferably, the pulling carriage 30 has at least two, in the illustrated embodiment four, blind holes 31 lying next to one another in the longitudinal direction, wherein each of the blind holes 31 has a lateral slot 32 pointing towards the distal end 30a of the pulling carriage 30. The lateral slots 32 extend in particular to the respective distally adjacent blind hole 31, so that a longitudinal groove 36 is formed which extends over all blind holes 31 and extends to the distal end 30a of the pulling carriage 30. The second fastening device 42 of the pulling element 40 can be inserted into one of the blind holes 31. Due to the round cross-section of the blind hole 31 and the partially spherical element 43 a good positioning can be achieved. The pin-like element 44 enables good alignment by lying in the longitudinal groove 36. The blind hole 31 located closest to the proximal end 30b of the pulling carriage 30 can have a lateral slot 33 pointing towards the proximal end 30b of the pulling carriage 30, in which the pin-like element 44 projecting beyond the partially spherical element 43 can come to rest.

If the second fastening device 42 is inserted into the blind hole 31, the pulling element 40 can be guided through the longitudinal groove 36 to the deflection part 23 and from there, after deflection through the opening 25a, to the underside 21b of the base element 20 and further to the tooth to be extracted (see in particular FIGS. 1 and 3).

At the distal end 20a of the base element 20, on an underside 21b of the base element 20, in particular distal of the opening 25a, a first support element 27 can be arranged, preferably detachably fastened, which has a positioning contour 27a for aligning the pulling element 40.

With the support element 27, the device 10 can be positioned in the oral cavity. The positioning contour 27a forms an alignment aid for the pulling element 40 and guides the pulling element 40, which is guided over the deflection part 23 and which may initially be deflected by significantly less than 90° due to its rigidity, into the desired alignment. The positioning contour 27a can, for example, be concave. In particular, the positioning contour 27a can be V-shaped (see in particular FIG. 2).

Furthermore, at least one second support element 28 can be arranged, preferably detachably fastened, on the underside 21b of the base element 20, in particular proximal to the opening 25a.

The detachable fastening of the first support element 27 and/or the second support element 28 can be realized, for example, in that at least one, preferably two, pins 27b, 28b, per support element 27, 28 are arranged on the underside 21b of the base element 20 to prevent rotation, which pins engage in recesses 27c, 28c arranged on the respective support element 27, 28 in a substantially frictionally engaged manner. To increase the frictional engagement, circumferential rubber rings 27d, 28d can be arranged on the pins 27b, 28b (see in particular FIG. 2).

The actuating element 60, which can be actuated in particular manually, comprises a torque limiting device 70, which is shown in particular in FIGS. 6, 7 and 8. The torque limiting device 70 is in particular a purely mechanical torque limiting device 70. The torque limiting device 70 may comprise a first clutch disc 71 and a second clutch disc 72, which are frictionally connectable. The first clutch disc 71 has an inner edge 71a and an outer edge 71b. The outer edge 71b is essentially smooth in the present case. At least one projection 71c, in this case three projections 71c, can be arranged on the inner edge 71a. The second clutch disc 72 has an inner edge 72a and an outer edge 72b. The inner edge 72a is essentially smooth in the present case. At least one projection 72c, in this case three projections 72c, can be arranged on the outer edge 72b.

The actuating element 60 may have a torque shaft 80, which in particular has a first axial section 80a and a second axial section 80b. The actuating element 60 can be connected to the tensioning device 50 by means of the second axial section 80b.

For this purpose, the internal thread 61 can be arranged in the second axial section 80b, in particular starting from the free end face of the second axial section 80b, with which the actuating element 60 can be screwed onto the threaded rod 35. The first clutch disc 71 can be arranged in a rotationally fixed manner on the torque shaft 80, in particular on the first axial section 80a. For this purpose, the torque shaft 80 can have at least one longitudinal groove 82, in the present case three longitudinal grooves 82, at least in sections, in particular in the first axial section 80a, into which the first clutch disc 71 engages with the projection 71c arranged on its inner edge 71a or the projections 71c arranged on its inner edge 71a.

The actuating element 60 can have a first housing part 90 on which the second clutch disc 72 is arranged in a rotationally fixed manner, wherein the first housing part 90 is arranged rotatably mounted against the torque shaft 80. For this purpose, the first housing part 90 can have a cylindrical wall 92, wherein at least one longitudinal groove 93, in the present case three longitudinal grooves 93, is arranged in the wall 92, into which the second clutch disc 72 with the projection 72c arranged on its outer edge 72b or the projections 72c arranged on its outer edge 72b.

The first housing part 90 may have a bottom surface 91, wherein an opening 94 is arranged in the bottom surface 91, through which the torque shaft 80 with the first section 80a is guided into the first housing part 90, wherein a contact surface 83 for the first housing part 90 is arranged on the torque shaft 80.

On the torque shaft 80, in particular on the first section 80a, an external thread 84 is arranged, in particular adjacent to an end face of the torque shaft 80, onto which an adjusting nut 73 can be screwed. In particular, the first clutch disc 71 and the second clutch disc 72 are arranged between the bottom surface 91 of the first housing part 90 and the adjusting nut 73.

Furthermore, at least one disc spring 74 can be arranged between the bottom surface 91 of the first housing part 90 and the adjusting nut 73. In the present embodiment, two disc springs 74 are arranged there, in particular in opposite directions. The disc springs 74 have an inner edge 74a and an outer edge 74b which is substantially smooth, so that the disc springs 74 are arranged so as to be rotatable both with respect to the torque shaft 80 and with respect to the first housing part 90.

At least one spacer disk 75 can be arranged between the bottom surface 91 of the first housing part 90 and the first clutch disk 71 and/or between the second clutch disk 72 and the at least one disc spring 74 and/or between the at least one disc spring 74 and the adjusting nut 73. The spacer disk 75 has an inner edge 75a and an outer edge 75b which is substantially smooth so that the spacer disk 75 is arranged so as to be rotatable both with respect to the torque shaft 80 and with respect to the first housing part 90.

In the present exemplary embodiment, the following components are arranged in a row on the first section 80a of the torque shaft 80 which is guided through the opening 94 in the bottom surface 91 of the first housing part 90: first one of the spacer disks 75, followed by the second clutch disk 72, followed by the first clutch disk 71, followed by two further spacer disks 75, followed by the two disc springs 74, followed by another of the spacer disks 75 and followed by the adjusting nut 73. Following the adjusting nut 73, a lock nut 73b can be screwed.

A second housing part 95 can be screwed onto the first housing part 90 in order to cover the aforementioned components and to form a housing for the actuating element 60 that is easy to handle for the user. The second housing part 95 may have a ribbing or structure 95a on the outer surface to enable a user to have a better grip. In this case, a sealing ring 96 can be arranged between the first housing part 90 and the torque shaft 80 and/or a sealing ring 97 can be arranged between the second housing part 95 and the torque shaft 80.

By means of the adjusting nut 73, the above-mentioned components are pressed together until the two clutch discs 71, 72 are in frictional contact with one another. Depending on how far the adjusting nut 73 is tightened, the torque at which the torque limiting device 70 is triggered can be adjusted. If a torque is applied to the torque shaft 80 which is lower than the torque at which the torque limiting device 70 is triggered, the two clutch discs 71, 72 are in frictional contact with each other, and when the first housing part 90 rotates, the torque shaft 80 is driven.

The actuating element 60 is screwed onto the threaded rod 35 by means of the internal thread 61 and is supported on the support sleeve 29. Upon rotation of the actuating element 60, in particular of the first housing part 90 or of the second housing part 95 connected thereto, the pulling carriage 30 is pulled towards the proximal end 20b of the base element 20 and a tensile force is exerted on the tooth to be extracted via the pulling element 40. If a torque is applied to the torque shaft 80 which is greater than the torque at which the torque limiting device 70 is triggered, the two clutch discs 71, 72 are pulled apart and the frictional engagement is released, so that upon further rotation of the first housing part 90 the torque shaft 80 is no longer driven.

To clean the device 10, the actuating element 60 can first be unscrewed from the threaded rod 35. The support sleeve 29 can then be unscrewed from the base element 20. For this purpose, the actuating element 60 can have an inner contour, in particular on its end face facing away from the internal thread 61, which can be placed in a form-fitting manner on an outer contour 29a of the support sleeve 29. The pulling carriage 30 can then be pulled out of the base element 20 (see in particular FIG. 2).

### REFERENCE SYMBOL LIST

10 device
20 base element
20a distal end
20b proximal end
21a upper side
21b underside
22a first section
22b second section
23 deflection part
24 measurement standard
25 groove
25a opening
26 through-opening
27 first support element
27a positioning contour
27b pin
27c recess
27d rubber ring
28 first support element
28b pin
28c recess
28d rubber ring
29 support sleeve
29a outer contour
30 pulling carriage
30a distal end
30b proximal end
31 blind hole
32 lateral slot
33 lateral slot
34 marking
35 Threaded rod
36 longitudinal groove
40 pulling element
40a first end
40b second end
42 second fastening device
43 partially spherical element
44 pin-like element
50 tensioning device
53 spring element
60 actuating element
61 internal thread
70 torque limiting device
71 first clutch disc
71a inner edge
71b outer edge
71c projection
72 second clutch disc
72a inner edge
72b outer edge
72c projection
73 adjusting nut
73b lock nut
74 disc spring
74a inner edge
74b outer edge
75 spacer disc
75a inner edge
75a outer edge
80 torque shaft
80a first section
80b second section
82 longitudinal groove
83 contact surface
84 external thread
90 first housing part
91 bottom surface
92 wall
93 longitudinal groove
94 opening
95 second housing part
95a structure
96 sealing ring
L Longitudinal axis
DK diameter
DS diameter
DZ diameter
LK length
LS length

1-30. (canceled)

31. Device (10) for tooth extraction, comprising a base element (20) with a longitudinal axis (L), a distal end (20a) and a proximal end (20b), and a pulling carriage (30) which can be moved relative to the base element (20) and has a distal end (30a) and a proximal end (30b), and comprising a pulling element (40) having a first end (40a) and a second end (40b), wherein a first fastening device (41) for fastening to the tooth or a fastening body fastened to the tooth is arranged at the first end (40a), and a second fastening device (42) for fastening to the pulling carriage (30) is arranged at the second end (40b), wherein the pulling element (40) is guided via a deflection part (23) arranged on the base element (20), wherein a tensioning device (50) for generating a tensile force is arranged on the pulling carriage (30), wherein the tensioning device (50) can be actuated by means of an actuating element (60) which is rotatable about the longitudinal axis (L), characterized in that the actuating element (60) comprises a torque limiting device (70) and that the actuating element (60) is manually operable and the torque limiting device (70) is designed as a mechanical torque limiting device (70).

32. Device according to claim 31, characterized in that the torque limiting device (70) comprises a first clutch disc (71) and a second clutch disc (72) which can be connected by friction.

33. Device according to claim 31, characterized in that the actuating element (60) has a torque shaft (80) which can be connected to the tensioning device (50) and on which the first clutch disc (71) is arranged in a rotationally fixed manner, and in that the actuating element (60) has a first housing part (90) on which the second clutch disc (72) is arranged in a rotationally fixed manner, wherein the first housing part (90) is arranged so as to be rotatable relative to the torque shaft (80).

34. Device according to claim 33, characterized in that the torque shaft (80) has at least one longitudinal groove (82) at least in sections, and wherein the first clutch disc (71) has on its inner edge (71b) a projection (71c) engaging in the longitudinal groove (82).

35. Device according to claim 34, characterized in that the first housing part (90) has a cylindrical wall (92), wherein at least one longitudinal groove (93) is arranged in the wall (92), and wherein the second clutch disc (72) has on its outer edge (72a) a projection (72c) engaging in the longitudinal groove (93).

36. Device according to claim 34, characterized in that the first housing part (90) has a bottom surface (91), wherein an opening (94) is arranged in the bottom surface (91) through which the torque shaft (80) is guided with a first section (80a) into the first housing part (90), wherein a contact surface (83) for the first housing part (90) is arranged on the torque shaft (80).

37. Device according to claim 34, characterized in that an external thread (84) is arranged on the torque shaft (80), in particular on the first section (80a), onto which an adjusting nut (73) can be screwed, wherein the first clutch disc (71) and the second clutch disc (72) are arranged between the bottom surface (91) of the first housing part (90) and the adjusting nut (73).

38. Device according to one claim 37, characterized in that at least one disc spring (74) is arranged between the bottom surface (91) of the first housing part (90) and the adjusting nut (73), preferably two disc springs (74) are arranged.

39. Device according to claim 34, characterized in that at least one spacer disk (75) is arranged between the bottom surface (91) of the first housing part (90) and the first clutch disk (71) and/or between the second clutch disk (72) and the at least one disc spring (74) and/or between the at least one disc spring (74) and the adjusting nut (73).

40. Device according to claim 34, characterized in that a second housing part (95) can be screwed onto the first housing part (90).

41. Device according to claim 34, characterized in that a sealing ring (96, 97) is arranged between the first housing part (90) and the torque shaft (80) and/or between the second housing part (95) and the torque shaft (80).

42. Device according to claim 31, characterized in that the pulling element (40) is designed as a wire, a rope or a string.

43. Device according to claim 31, characterized in that the second fastening device (42) comprises a partially spherical element (43) with a diameter (DK) which is greater than the diameter (DZ) of the pulling element (40), wherein in particular a longitudinal axis of the pulling element (40) is arranged coaxially to an axis of symmetry of the partially spherical element (43), and wherein the pulling carriage (30) has at least one blind hole (31) which has a lateral slot (32) pointing towards the distal end (30a) of the pulling carriage (30).

44. Device according to claim 43, characterized in that the pulling carriage (30) has at least two, preferably four, blind holes (31) lying next to each other in the longitudinal direction
wherein each of the blind holes (31) has a lateral slot (32) pointing towards the distal end (30a) of the pulling carriage (30).

45. Device according to claim 43, characterized in that the second fastening device (42) comprises a pin-like element (44) with a diameter (DS) which is greater than the diameter (DZ) of the pulling element (40) and with a longitudinal axis which is arranged parallel to the longitudinal axis of the pulling element (40), wherein the partially spherical element (43) is arranged on the pin-like element (44), and the diameter (DK) of the partially spherical element (43) is greater than the diameter (DS) of the pin-like element.

46. Device according to claim 45 characterized in that the pin-like element (44) is designed as a press bushing into which the pulling element (40) is pressed.

47. Device according to claim 45, characterized in that the pin-like element (44) has a length (LS) which is greater than the length (LK) of the partially spherical element (43), wherein in particular the pin-like element (44) projects in the longitudinal direction on both sides beyond the partially spherical element (43).

48. Device according to claim 43, characterized in that the blind hole (31) closest to the proximal end (30b) of the traction carriage (30)
has a lateral slot (33) pointing towards the proximal end (30b) of the pulling carriage (30).

49. Device according to claim 31, characterized in that the base element (20) has a measurement standard (24) and a marking (34) for interacting with the measurement standard (24) is arranged on the pulling carriage (30).

50. Device according to claim 31, characterized in that the base element (20) is open in a first section (22a) to an upper side (21a) and has a groove (25) running in the longitudinal direction, wherein the pulling carriage (30) is arranged to be longitudinally displaceable in the groove (25).

51. Device according to claim 50, characterized in that the base element (20), starting from the proximal end (20b), has a second section (22b) in which the base element (20) is tubular with an axial through-opening (26), wherein the through-opening (26) merges into the groove (25) of the first section (22a), and the pulling carriage (30) is arranged to be longitudinally displaceable in the groove (25) and the through-opening (26).

52. Device according to claim 31, characterized in that the deflection part (23) is attached to a distal end of the groove (25) and the groove (25) has an opening (25a) below the deflection part (23).

53. Device according to claim 31, characterized in that at the distal end (20a) of the base element (20) on an underside (21b) of the base element (20), in particular distal of the opening (25a), a first support element (27) is arranged, preferably detachably fastened, which has a positioning contour (27a) for aligning the pulling element (40).

54. Device according to claim 53, characterized in that the positioning contour (27a) is concave.

55. Device according to claim 53, characterized in that the positioning contour (27a) is V-shaped.

56. Device according to claim 31, characterized in that at least one second support element (28) is arranged, preferably detachably fastened, on an underside (21b) of the base element (20), in particular proximal to the opening (25a).

57. Device according to claim 31, characterized in that the tensioning device (50) comprises a threaded rod (35) arranged at the proximal end (30b) of the pulling carriage (30), which is led out of the base element through a support sleeve (29) arranged at the proximal end (20b) of the base element (20, wherein the actuating element (60) is screwed onto the threaded rod (35) with an internal thread (61) and is arranged so as to be axially supported on the support sleeve (29) in order to generate the tensile force, and wherein between the pulling carriage (30) and the support sleeve (29) a spring element (53) is arranged to generate a restoring force.

58. Device according to claim 31, characterized in that the support sleeve (29) is screwed onto the proximal end (20b) of the base element (20) by means of a threaded connection.

59. Device according to claim 31, characterized in that the actuating element (60) has an inner contour which can be placed in a form-fitting manner on an outer contour (29a) of the support sleeve (29).
